(19) United States
(12) Patent Application Publication
(10) Pub. No.: US 2025/0305399 A1
(43) Pub. Date: Oct. 2, 2025

(54) FORMATE SLICKWATER FLUIDS AND METHODS FOR USE THEREOF FOR CARBON STORAGE IN CONJUNCTION WITH A STIMULATION OPERATION

(71) Applicant: SAUDI ARABIAN OIL COMPANY, Dhahran (SA)

(72) Inventors: Murtadha J. ALTAMMAR, Dhahran (SA); Khalid M. ALRUWAILI, Dhahran (SA)

(73) Assignee: SAUDI ARABIAN OIL COMPANY, Dhahran (SA)

(21) Appl. No.: 18/619,329

(22) Filed: Mar. 28, 2024

(51) Int. Cl. C09K 8/68; C09K 8/80

(52) U.S. Cl. CPC E21B 43/26; C09K 8/62; C09K 8/68; C09K 8/80; C09K 2208/24

(57) ABSTRACT

Slickwater fluids comprising aqueous formate fluids may promote underground carbon storage. In an aspect, slickwater fluids may be a slickwater fracturing fluid comprising: an aqueous formate fluid; proppant particulates; and optionally, one or more additives. Methods for use of a slickwater fluid as a slickwater fracturing fluid may comprise: contacting a slickwater fracturing fluid comprising an aqueous formate fluid; proppant particulates; and optionally, one or more additives; with a matrix of the subterranean formation above a fracture gradient pressure thereof to create or extend one or more fractures therein; and retaining at least a portion of the formate anions within the subterranean formation.

### FIELD OF THE DISCLOSURE

The present disclosure relates generally to underground carbon storage and, more particularly, underground carbon storage conducted in conjunction with stimulation of a subterranean formation.

### BACKGROUND OF THE DISCLOSURE

Hydrocarbons such as crude oil and natural gas are produced from oil and gas wells within hydrocarbon reservoirs with porous/permeable walls. Unconventional hydrocarbon reservoirs are reservoirs with hydrocarbons trapped by a formation matrix having low permeability. Methods for increasing hydrocarbon mobility may involve hydraulic fracturing, in which a hydraulic fracturing fluid is flowed through the reservoirs at high pressure and a high flow rate, such that a fracture gradient pressure of the subterranean formation is exceeded. The high pressure fractures the matrix of the subterranean formation to increase hydrocarbon mobility.

Some hydrocarbon reservoirs include an organic material called kerogen intertwined with the formation matrix, which can drastically increase the tensile strength of the formation matrix. As a result, significant energy can be required to propagate fractures in these types of reservoirs. Diverting fracturing is a common method for increasing the permeability of previously fractured reservoirs by filling initial fractures with proppant particulates (e.g., sand) to hold the fractures open, thereby raising the internal pressure of the reservoir to promote opening of new fractures. One popular diverting fracturing technique is slickwater fracturing, which injects a mixture of chemicals, water, and proppant into a formation (e.g., an oil or gas well). Low-viscosity slickwater is commonly used to improve fracture conductivity in ultra-tight formations, such as shale formations. Low-viscosity slickwater fracturing fluids are distinguished from viscosified slickwater fracturing fluids, which utilize a viscosifying polymer (e.g., a gelling agent) to facilitate transport of proppant particulates.

Hydraulic fracturing operations have been performed with additives that disintegrate kerogen and/or other organic matter within hydrocarbon reservoirs, thus increasing permeability of the formation matrix, to increase hydrocarbon production via the generated fractures. The heterogeneous kerogen matrix consists of building blocks composed of large alkyl and alkenyl fragments joined by resorcinol units. Kerogens may differ based on the type of subterranean formation in which they are located. For example, kerogen in shale formations is primarily an aliphatic-branched macromolecule crosslinked with aromatic, usually phenolic, units and differently bonded oxygen atoms in various ratios. Standard degradation methods, which cleave kerogen into lower molecular weight compounds, may occur at high temperatures (e.g., pyrolysis) or with chemicals (e.g., acids, bases, oxidants) at high or low temperatures. The amount of soluble kerogen in a sediment depends on the solvent used, the extraction conditions, and the physical and chemical properties of the sediment itself. The solvent power is dependent on its physical and chemical properties and the temperature used. Acids and bases may dissolve non-kerogen portions of shale such as carboxylic acids and their analogs (unbranched aliphatic acids, branched acids, dicarboxylic acids, keto acids, and aromatic acids), while oxidants may dissolve kerogens and produce fractures within shale formations. However, these treatments may be unsustainable, toxic, explosive, or only partially effective. Pyrolysis, for example, decomposes organic matter into non-condensable gases, condensable liquids, and solid residue, biochar, or charcoal, which may cause large CO₂ emissions. Chemical treatments, such as oxidants, are often not environmentally friendly.

Carbon dioxide (CO₂) (gas or supercritical fluid) has been injected into hydrocarbon reservoirs as an additional fracturing agent in hydraulic fracturing operations to enhance production of oil and gas from the reservoirs, as well as for underground carbon storage. CO₂ can create complex fractures with large surface areas and interact with reservoir surfaces, increasing release of methane and other gases from kerogen, while also acting as a clay stabilizer. Although effective for various purposes, including for underground carbon storage, CO₂ injection into hydrocarbon reservoirs may have several disadvantages, such as safety concerns, cost, inefficient use of pore space, corrosion of pipelines and other metal surfaces, leakage of CO₂ through unexpected hydraulic pathways, decreased solubility due to salinity (e.g., brines) and temperature, and poor rheological properties (e.g., low density and viscosity) leading to poor carrying capacity for proppant particulates during a fracturing operation. When used in conjunction with fracturing of shale formations or other formations containing kerogen, one or more of the foregoing may be especially problematic.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to embodiments consistent with the present disclosure, slickwater fracturing fluids comprise: an aqueous formate fluid comprising about 5 weight percent (wt %) to about 50 wt % of formate anions, based on a total weight of the slickwater fracturing fluid; proppant particulates; and optionally, one or more additives.

According to further embodiments consistent with the present disclosure, method for underground carbon storage comprise: introducing a slickwater fracturing fluid into a subterranean formation, wherein the slickwater fracturing fluid comprises: an aqueous formate fluid comprising about 5 weight percent (wt %) to about 50 wt % of formate anions, based on a total weight of the slickwater fracturing fluid; proppant particulates; and optionally, one or more additives; contacting the slickwater fracturing fluid with a matrix of the subterranean formation above a fracture gradient pressure thereof to create or extend one or more fractures therein; and retaining at least a portion of the formate anions within the subterranean formation.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Not applicable.

### DETAILED DESCRIPTION

Embodiments in accordance with the present disclosure generally relate to underground carbon storage and, more particularly, underground carbon storage conducted in conjunction with stimulation of a subterranean formation.

In the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description.

In response to the difficulties associated with stimulating a subterranean formation (particularly an ultra-tight formation (e.g., a shale formation)) the present disclosure provides slickwater fluids comprising an aqueous formate fluid. Slickwater fluids of the present disclosure may provide advantages over previous pure CO₂ or hybrid slickwater/CO₂ systems. Leading advantages of the aqueous formate fluids of the present disclosure are the speed and safety of pumping a dense and viscous liquid instead of a gas or supercritical fluid during a stimulation operation. Further, formate anions may bind to kerogen and release methane and other gases, while performing the role of various other additives (e.g., clay stabilizer, pH adjuster, weighting agent, the like, and any combination thereof) in various slickwater fluids. Binding of the formate anions to kerogen or other organic matter may further improve the effectiveness of a fracturing operation.

Additionally, the slickwater fluids of the present disclosure may facilitate simultaneous underground carbon storage during a fracturing operation by retaining at least a portion of the formate anions in the subterranean formation following stimulation. The formate anions may remain within the subterranean formation by virtue of binding to kerogen or while remaining dispersed in an aqueous fluid that is not produced to the Earth's surface following completion of the fracturing operation. Because formate anions and carbon dioxide are similar in molecular weight (2 atomic mass unit difference), formate anions and carbon dioxide may store a comparable amount of carbon on a molar basis. Because the density of formate brines may exceed that of supercritical carbon dioxide, storage of formate anions downhole may afford even greater carbon storage capacity than is possible with carbon dioxide alone.

As used herein, the term “subterranean formation,” and grammatical variants thereof, refer to naturally occurring rock beneath the Earth's surface, including subsea surfaces. Subterranean formations may be formed from a variety of natural rock, referred to as a formation matrix, including, but not limited to, carbonate-based rock (e.g., calcium carbonate (CaCO₃)), calcium magnesium carbonate (CaMg(CO₃)₂) (also referred to as dolomite), sandstone-based rock comprising clays (e.g., smectite, illite, kaolinite, chlorite, the like, and any combination thereof), each of which include minerals (e.g., siliceous material) the like, and any combination thereof. The subterranean formations described herein encompass reservoir zones (i.e., zones comprising hydrocarbons, also referred to herein as “hydrocarbon reservoirs”) and non-reservoir zones (i.e., zones that do not include hydrocarbons, such as water-producing zones). Suitable subterranean formations, or a hydrocarbon reservoir contained therein, may comprise kerogen or other organic matter that may impede reservoir conductivity. Examples of suitable subterranean formations include, but are not limited to, shales, cherts, marls, the like, and any combination thereof. The kerogens present in a subterranean formation are not particularly limited and may differ depending on the type of subterranean formation undergoing stimulation according to the disclosure herein.

As used herein, the terms “subterranean operation” and “upstream operation,” and grammatical variants thereof, refer to any operation (e.g., drilling, completion, stimulation, enhanced recovery, production, and waste storage) involved in production of petroleum, natural gas, as well as other resources, such as water or helium, from a subterranean formation. A subterranean formation may contain an existing injection well, an existing production well, a deep abandoned shallow single and/or multi-lateral well. In particular examples of the present disclosure, the slickwater fluids may be utilized in conjunction with a stimulation operation.

As used herein, the terms “well,” “wellbore,” and grammatical variants thereof, refer to a drilled hole or borehole penetrating a subterranean formation, which may be cased (cemented) or uncased (open hole).

As used herein, the term “slickwater fluid,” and grammatical variants thereof, refers generally to any non-viscosified aqueous fluid, viscosified aqueous fluid, or hybrid thereof, designed or suitable for use in a subterranean operation to achieve a desired purpose. A “slickwater fracturing fluid” may be a slickwater fluid configured to perform a fracturing operation with a subterranean formation of a specified type (e.g., a slickwater fracturing fluid may be a slickwater fluid further comprising proppant particulates and optional chemicals or additives).

As used herein, an “enzyme,” and grammatical variants thereof, refers to a protein capable of acting as a biological catalyst to accelerate a chemical reaction, or a domain thereof possessing said catalytic activity. An enzyme may be a naturally derived or artificial (e.g., synthetic) enzyme. As used herein, a naturally derived enzyme may be derived from a plant enzyme, an animal enzyme, a microbial (e.g., bacterial, fungal, yeast, or the like) enzyme, or the like. As used herein, an artificial (e.g., synthetic) enzyme may be based on a naturally derived enzyme.

The present disclosure provides slickwater fluids comprising an aqueous formate fluid and methods for use thereof. The slickwater fluids of the present disclosure are capable of facilitating underground carbon storage while concurrently enhancing hydrocarbon production from the subterranean formation by performing a stimulation operation, such as fracturing. In one or more embodiments, the present disclosure provides slickwater fluids which are configured to promote hydraulic fracturing, and methods for using the same in conjunction with performing subterranean operations. At least a portion of the slickwater fluids and the formate anions therein may remain within the subterranean formation following fracturing, thereby sequestering at least a portion of the carbon of the formate anions within the subterranean formation in a form that is readily maintained within the subterranean formation.

In one or more embodiments, slickwater fluids of the present disclosure are suitable for use in subterranean formations, including, but not limited to, saline aquifers (e.g., sandstones and the like), oil reservoirs (e.g., for enhanced oil recovery and carbon storage), unconventional formations (e.g., shale formations, tight sandstones, tight carbonates, tight coals, the like, and any combination thereof), or the like.

Slickwater fluids of the present disclosure may be used in various subterranean operations. Nonlimiting examples of subterranean operations for which a slickwater fluid may be designed and used include enhanced oil recovery operations (e.g., water, chemical, or gas (e.g., CO₂) flooding operations), fracturing operations, acidizing operations, gravel-packing operations, or the like, or any combination thereof. Preferably, the slickwater fluids of the present disclosure may be used in conjunction with a fracturing operation, since doing so may both improve production of a natural resource from the subterranean formation and facilitate underground carbon storage.

In various embodiments, suitable slickwater fluids may comprise a slickwater fracturing fluid configured for performing hydraulic fracturing. Slickwater fracturing fluids suitable for performing hydraulic fracturing may be, for example, a plug-and-perf fluid (e.g., a hydraulic fracturing slickwater fracturing fluid designed to be injected into a subterranean formation via a perforated and isolated well casing). Slickwater fracturing fluids of the present disclosure may be utilized for refracturing a subterranean formation (e.g., for injection into a previously fractured subterranean formation in which productivity has decreased over time). In various embodiments, the slickwater fracturing fluids comprise a low-viscosity aqueous fluid (e.g., an aqueous formate fluid), proppant particulates (e.g., sand or other particulate materials), and optional chemicals (i.e., additives).

The slickwater fluids as described herein may comprise aqueous formate fluids, such as aqueous-based formate solutions. Aqueous-based formate solutions of the present disclosure may include fresh water, saltwater, brine, seawater, wastewater, purified wastewater, the like, or any combination thereof. The aqueous-based formate fluid may comprise a formate brine in one or more embodiments. The slickwater fluids may include various components suitable for a particular subterranean formation operation or other downstream operation.

Formate refers to the formate anion (HCOO⁻), which dissociates in aqueous solution of formic acid and/or salts thereof, or upon hydrolysis of formate esters. Formate salts such as sodium, potassium, cesium, or the like, or blends of said formate salts, such as sodium/potassium formate blends, are highly soluble in water, with maximum solubilities of about 30 weight percent (wt %) to about 80 wt % of formate anion, based on total fluid mass, may be present in the aqueous formate fluids. Aqueous formate solutions also have relatively high densities, with maximum densities up to 1.3 g/cm³ (10.8 pounds per gallon (ppg)) for sodium formate, up to 1.57 g/cm³ (13.1 ppg) for potassium formate, and up to 2.3 g/cm³ (19.2 ppg) for cesium formate.

In various embodiments, slickwater fluids suitable for performing hydraulic fracturing may comprise an aqueous formate solution having at least about 5 weight percent (wt %) of formate anions, based on the total weight of the slickwater fluid (e.g., at least about 5 wt %, 10 wt %, 15 wt %, 20 wt %, 25 wt %, 30 wt %, 35 wt %, 40 wt %, 45 wt %, 50 wt %, or greater). In various embodiments, slickwater fluids comprising an aqueous formate solution may comprise about 5 wt % to about 50 wt %, including any wt % value or range therebetween, of formate anions, based on the total weight of the slickwater fluid (e.g., about 5 wt % to about 30 wt %, about 30 wt % to about 50 wt %, about 10 wt % to about 40 wt %, about 15 wt % to about 35 wt %, or about 20 wt % to about 30 wt %). In various embodiments, slickwater fluids comprising an aqueous formate solution may comprise about 30 wt % to about 50 wt % of formate anions, based on the total weight of the slickwater fluid. In various embodiments, slickwater fluids may comprise a saturated aqueous formate solution.

Slickwater fluids may comprise various formate compounds capable of generating formate anions, such as by dissociation or reaction, e.g., hydrolysis of a formate ester. Formate compounds may comprise formic acid, a formate salt, a formate salt hydrate, a formate ester, or any combination thereof. A formate salt may comprise a single formate salt or a mixture of two or more formate salts. Suitable formate salts include, but are not limited to, alkali metal formate salts, alkali earth metal formates, or the like. Examples of suitable formate salts include, but are not limited to, sodium formate, potassium formate, cesium formate, lithium formate, calcium formate, magnesium formate, ammonium formate, the like, or any combination thereof. In some embodiments, suitable formate salts may comprise sodium formate, potassium formate, and/or cesium formate. In some embodiments, an aqueous formate solution may comprise a buffer (e.g., an acidic buffer) of formic acid and one or more formate salts. In an embodiment, an acidic formic acid-formate salt buffer may have a pH of about 3 to about 4, including all pH values and ranges therebetween. A formate ester may comprise a single formate ester or a mixture of two or more formate esters. Suitable formate esters may include methyl formate, the like, or any combination thereof.

A slickwater fluid comprising an aqueous formate fluid may comprise various solution densities. In various embodiment, an aqueous formate fluid may have a density of about 1.05 g/cm³ to about 2.3 g/cm³, including all g/cm³ values and ranges therebetween (e.g., from about 1.05 g/cm³ to about 1.5 g/cm³, from about 1.5 g/cm³ to about 2 g/cm³, from about 2 g/cm³ to about 2.5 g/cm³, or greater). In various embodiment, an aqueous formate fluid may have a density of about 1.1 g/cm³ to about 1.5 g/cm³.

Slickwater fluids comprising an aqueous solution of a formate salt may have a pH about 4 to about 10, including all pH values and ranges therebetween. A slickwater fluid comprising an aqueous formate solution may comprise a formate buffer (e.g., a mixture of formic acid with one or more formate salts). A slickwater fluid comprising an aqueous formate buffer may have a pH of about 4 to about 10, including all pH values and ranges therebetween.

Slickwater fluids of the present disclosure may further comprise one or more additives suitable for a particular subterranean operation. Suitable examples of slickwater fluid additives include, but are not limited to, a proppant, a friction reducer, a diverter, a surfactant, a clay stabilizer, a scale inhibitor, a biocide, a corrosion inhibitor, a gelling agent, a crosslinking agent, an iron control agent, a pH-adjusting agent, a non-formate salt, a gel breaker, a weighting agent, or the like, or any combination thereof. For example, slickwater fracturing fluids may comprise a proppant (proppant particulates) and be formulated for conducting hydraulic fracturing.

The slickwater fracturing fluids of this disclosure may include breakers that may degrade gelling polymers or other viscosified fluids within the subterranean formation. Suitable breakers include acid breakers, bacteria-based breakers, enzyme breakers, oxidative breakers, the like, and any combination thereof. Common polymers broken by a breaker include guar, hydroxypropyl guar, xanthan gum, the like, and any combination thereof. The breakers may be encapsulated or not encapsulated. When used, breakers may be present in the slickwater fracturing fluid in a range from about 0.003 wt % to about 1.3 wt %, based on the total weight of the slickwater fracturing fluid.

In an embodiment, an aqueous formate solution may serve as a buffer and breaker system. A formate buffer and breaker system may comprise a formic acid-formate anion buffer and a formate ester. A formic acid-formate anion buffer provides a pH of 3-4 to maintain viscosity and stabilize any crosslinkers. After fracturing is complete, the formate ester may decompose and release formic acid to lower the pH further. The decreased pH may promote degradation of any polymer gels that may be present. Common polymers broken by a formate breaker system include guar, hydroxypropyl guar, xanthan gum, the like, and any combination thereof.

An aqueous formate solution of the present disclosure may perform additional roles in a slickwater fluid, such as a slickwater fracturing fluid. In various embodiments, an aqueous formate solution may interact with subterranean formation surfaces (e.g., fracture surfaces induced by a fracturing operation, or the like) to adsorb onto kerogen and/or other organic matter, potentially releasing adsorbed methane and other gases. An aqueous formate solution may also release carbon dioxide, which similarly may adsorb onto kerogen and/or other organic matter, thereby releasing adsorbed methane or the like. An aqueous formate solution may interact with subterranean formation surfaces to adsorb onto clay, preventing swelling during operations, which can cause damage to and reduce permeability of the subterranean formation. A slickwater fluid comprising a high-density aqueous formate solution may also require lower pressure and/or flow rate to achieve the same level of reservoir stimulation, thus reducing the risk of formation damage. An aqueous formate solution may comprise a formic acid-formate anion buffer and breaker system, in which the buffer maintains an acidic pH that hydrolyzes a breaker (e.g., a formate ester) and releases acid to break down gelled polymers. An acidic aqueous formate solution may also act as a fracturing agent in a subterranean formation.

In some embodiments, a slickwater fluid, such as a slickwater fracturing fluid, may further comprise one or more enzymes, one or more microbial organisms capable of generating the one or more enzymes, or any combination thereof, wherein the enzymes are capable of increasing hydrocarbon production in a subterranean formation. In an embodiment, one or more of the enzymes is capable of converting the formate anions of the slickwater fluid into CO₂, converting CO₂ into a gas, such as methane, degrading or disintegrating kerogen and/or other organic matter, or the like, or any combination thereof. In one example embodiment, an acidic pH may accelerate the activity of one or more of the enzymes. In one or more embodiments, the slickwater fluid may comprise one or more of the enzymes and an acidifying agent, e.g., an acid or an acidic buffer (e.g., an acidic formate buffer), which accelerates the activity of the enzymes.

Slickwater fluids may further comprise an enzyme and/or an organism capable of generating the enzyme, wherein the enzyme is capable of acting on the formate anions, carbon dioxide, or a substance within the subterranean formation, such as kerogen (e.g., to increase permeability, and thus productivity thereof). In some embodiments, the slickwater fluid may comprise one or more of the enzymes and an acidifying agent, e.g., an acid or an acidic buffer (e.g., an acidic formate buffer), which accelerates the activity of the enzyme(s). In some embodiments, one or more of the enzymes may be capable of converting the formate anions into CO₂, converting the formate anions or the CO₂ into methane, or the like. Examples of suitable enzymes may include, but are not limited to, a carboxylase, a decarboxylase, a dehydrogenase (e.g., format dehydrogenase), a methanogen-specific enzymes (e.g., methyl-coenzyme M reductase), the like, and any combination thereof.

In some embodiments, one or more of the enzymes may be capable of acting on kerogen and/or other organic material in a subterranean formation. An enzyme capable of acting on kerogen and/or other organic matter may dissolve or disintegrate kerogen and/or other organic material. As used herein, the terms “degrade” and “disintegrate,” and grammatical variants thereof, of “kerogen and/or other organic matter,” refer to the reaction of kerogen and/or other organic matter with a slickwater fluid of the present disclosure, whereby the kerogen and/or other organic matter undergoes a decomposition reaction. The degradation or disintegration of kerogen may produce gases, and this may further promote fracturing of the subterranean formation. The degradation or disintegration of kerogen may increase the porosity of the subterranean formation and may increase the subterranean formation's conductivity. Examples of suitable enzymes include, but are not limited to, a laccase, a hydrolase, an oxidoreductase, a lipase, the like, or any combination thereof. In one example embodiment, an acidic pH accelerates the activity of one or more of the enzymes.

Laccase enzymes are multicopper oxidases commonly used in oxidative degradation and removal of phenolic compounds such as methoxyphenols and polycyclic aromatic hydrocarbons (PAHs), as well as non-phenolic compounds such as aromatic amines, aryl amines, anilines, thiols, dyes, and pesticides. Hydrolytic enzymes (hydrolases) are among the common enzymes that can break macromolecules in a given organic matter into monomers. These enzymes are either produced outside microbial cells in the surrounded medium or are attached to the microbial cell surface. Oxoreductases are a group of enzymes including peroxidase, reductase, dehydrogenase, oxidase, oxygenase, and hydroxylase, and are involved in both aerobic and anaerobic metabolic reactions. These enzymes catalyze oxidoreduction reactions involving electron transfer in molecules. Oxoreductases enzymes are used for degradation of organic matter and contaminants due to their strong oxidative traits, broad substrate specificity, and low energy consumption. Lipase enzymes are considered as hydrolases enzymes involved in lipid metabolism. These enzymes are the most abundantly used industrial enzymes due to their capability in degrading organic matter and heavy oil remediation and bioengineering processes at large. In an embodiment, degrading kerogen and/or other organic matter within a subterranean formation by one or more of the lipase enzymes may form lower molecular weight compounds.

Examples of suitable bacteria which generate enzymes capable of acting on kerogen and/or other organic material in a subterranean formation include, but are not limited to, Actinobacteria, Pseudomonas, Mycobacterium, Sphingomonas, Bacillus, Achromobacter, the like, and any combination thereof. Examples of suitable fungi which generate enzymes capable of acting on kerogen and/or other organic material in a subterranean formation include, but are not limited to, Phanerochacte, Trametes, Bjerkandera, and Pleurotus, the like, and any combination thereof.

Slickwater fluids may further comprise enzymes capable of acting on other compounds within a subterranean operation, e.g., converting said compounds into gases and/or hydrocarbons. In various embodiments, the enzymes may be capable of converting other compounds within a subterranean formation into gases. The production of gases may further fracture the subterranean formation or may form hydrocarbons to supplement production from the subterranean formation.

Slickwater fracturing fluids of the present disclosure may comprise one or more oxidants capable of increasing hydrocarbon production from a subterranean formation. In some embodiments, suitable oxidants may be capable of acting on kerogen and/or other organic matter within a subterranean formation to achieve the benefits described above. In some embodiments, one or more of the oxidants may be capable of dissolving, degrading, or disintegrating kerogen, other organic matter, the like, or any combination thereof, within the subterranean formation. In some embodiments, degrading kerogen, other organic matter, the like, or any combination thereof, within a subterranean formation by one or more of the oxidants may form lower molecular weight compounds.

Oxidants for acting on kerogen, other organic matter, the like, or any combination thereof, within a subterranean formation include, but are not limited to, oxidizing acids, oxygen, ozone, oxides, halogens, halides, halogen oxyanions, peroxides, persulfates, permanganates, perborates, chromates, nitrates, bismuthates, the like, and any combination thereof. Suitable examples of oxidizing acids include, but are not limited to, perchloric acid, nitric acid, iodic acid, chromic acid, dichromic acids, chromium trioxide, sulfuric acids (e.g., peroxydisulfuric acid, peroxymonosulfuric acid), the like, and any combination thereof. Suitable examples of oxides include, but are not limited to, nitrous oxide, nitrogen dioxide, dinitrogen tetroxide, ruthenium tetroxide, lead dioxide, the like, and any combination thereof. Suitable examples of halogens include fluorine, chlorine, bromine, other halogens, and any combination thereof. Suitable examples of halides include, but are not limited to, fluorides of chlorine, bromine and iodine. Suitable examples of halogen oxyanions include, but are not limited to, hypochlorite (e.g., sodium hypochlorite), chlorites (e.g., sodium chlorite), chlorates, perchlorates, bromates (e.g., sodium bromate), the like, and any combination thereof. Suitable examples of chlorates include, but are not limited to, alkali metal (e.g., lithium, sodium, or potassium) chlorates, the like, and any combination thereof. Suitable examples of bromates include, but are not limited to, alkali metal (e.g., lithium, sodium, or potassium) bromates, the like, and any combination thereof. Suitable examples of peroxides include, but are not limited to, hydrogen peroxide, inorganic peroxides, the like, and any combination thereof. Suitable examples of persulfates include, but are not limited to, alkali metal (e.g., lithium, sodium, or potassium) persulfates, ammonium persulfate, the like, and any combination thereof. Suitable examples of permanganates include, but are not limited to, alkali metal (e.g., lithium, sodium, or potassium) permanganates, the like, and any combination thereof. Suitable examples of perborates include, but are not limited to, alkali metal (e.g., lithium, sodium, or potassium) perborates, the like, and any combination thereof. Suitable examples of chromates include, but are not limited to, hexavalent chromium compounds (e.g., pyridinium chlorochromate), chromate/dichromate compounds (e.g., sodium dichromate), the like, and any combination thereof. Suitable examples of nitrates include, but are not limited to, alkali metal (e.g., lithium, sodium, or potassium) nitrates, ceric ammonium nitrate, the like, and any combination thereof. Suitable examples of bismuthates include, but are not limited to, alkali metal (e.g., lithium, sodium, or potassium) bismuthates, the like, and any combination thereof. In an embodiment, an oxidant for acting on kerogen, other organic matter, the like, or any combination thereof, within a subterranean formation is selected from the group consisting of sodium bromate, ammonium persulfate, the like, and any combination thereof.

When used, slickwater fluids of the present disclosure may comprise various types and quantities of the one or more oxidants. In various embodiments, slickwater fracturing fluids may comprise from about 0.01 mol/L (M) to about 2 M, of the one or more oxidants, including all mol/L (M) values and ranges therebetween. As referenced above, slickwater fluids of the present disclosure (e.g., a slickwater fluid comprising an aqueous formate fluid, proppant particulates, and optionally, one or more additives) may be utilized in conjunction with hydraulic fracturing to enhance production from a subterranean formation, preferably by creating or enhancing one or more fractures within the matrix of a subterranean formation, while concurrently achieving underground carbon storage via the formate ions in the slickwater fluid. Such methods may be accomplished by introducing the slickwater fracturing fluid into the subterranean formation at or above a fracture gradient pressure of the subterranean formation, and thereafter retaining at least a portion of the formate anions within the subterranean formation.

Recovery rates for slickwater used in slickwater fracturing operations can vary across different shale basins. However, in US shale basins, for example, it is common for recovery rates of the injected water during flowback typically range from 20% to 40%. Therefore, from field experience, most water is not recovered, and formate salts present in the slickwater fluid may be retained within the subterranean formation to facilitate underground carbon storage. In addition, CO₂ has affinity to adsorb to organic matter or kerogen in shale matrix/fracture surfaces that leads to releasing methane and overall increased hydrocarbon production from fractured shale wells. While not being bound by theory, formate salts in the slickwater may interact with shale in a similar manner to bind formate thereto, thereby increasing hydrocarbon production while concurrently increasing the amount of equivalent carbon stored downhole. Retention of formate anions may be further encouraged by the limited production of slickwater following fracturing.

Accordingly, in various aspects, the present disclosure provides methods for use of slickwater fluids (e.g., slickwater fracturing fluids) comprising aqueous formate fluid in subterranean operations for underground carbon storage and enhanced hydrocarbon production from said subterranean formations. In various embodiments, methods for underground carbon storage and enhanced hydrocarbon production from subterranean formations may comprise use of any slickwater fluids of the present disclosure. Methods of the present disclosure may comprise: introducing a slickwater fluid to a subterranean formation during a subterranean operation; contacting the slickwater fluid with a matrix of the subterranean formation; and retaining at least a portion of the formate anions within the subterranean formation.

In various embodiments, at least a portion of the formate anions are stored within the subterranean formation. Storage of the formate anions within the subterranean formation may comprise removal and retention of the formate anions from the slickwater fluid by the subterranean formation during the subterranean operation (e.g., formate anions remain within the subterranean formation, such as through adsorption to the formation matrix, when the slickwater fluid returns to an injection well or a production well), or alternately, the slickwater fluid may remain within the subterranean formation to facilitate retention of the formate anions therein.

In various embodiments, such methods may stimulate a greater hydrocarbon production from the subterranean formation, as compared to the method using a corresponding slickwater fluid lacking the formate anions (e.g., a slickwater fluid comprising an alternate brine to a formate brine). In various embodiments, such method may promote about 1% to about 50% greater subterranean formation performance (production), including all % values and ranges therebetween, as compared to a method performed with a corresponding slickwater fluid lacking the formate anions.

In various embodiments, contacting the slickwater fluid with a subterranean formation may comprise injecting the slickwater fluid into the subterranean formation. Injecting the slickwater fluid into the subterranean formation may take place at a pressure and a flow rate sufficient to create and/or enlarge one or more fractures in the subterranean formation, and to force the slickwater fluid into existing and/or new fractures therein. In various embodiments, the slickwater fluid injected into the subterranean formation is a slickwater fracturing fluid comprising an aqueous formate fluid, proppant particulates, and optional chemicals (e.g., additives). In such embodiments, the slickwater fracturing fluid may be injected into the subterranean formation at a pressure and a flow rate sufficient to create and/or enlarge one or more fractures in the subterranean formation, and to force the slickwater fracturing fluid into existing and/or new fractures therein. Such methods may require a lower pressure and/or flow rate than a method performed with a corresponding slickwater fluid (e.g., a corresponding slickwater fracturing fluid) in the absence of the formate anions.

Contacting or injecting the slickwater fluid may comprise contacting or injecting the slickwater fluid into a separate portion of the subterranean formation from a production portion. Contacting or injecting the slickwater fluid may comprise contacting or injecting the slickwater fluid into the same portion of the subterranean formation as a production portion. Contacting or injecting the slickwater fluid may occur concurrently with production or contacting or injecting may be followed by a soaking period prior to production.

### EXAMPLE EMBODIMENTS

Embodiments disclosed herein include:

A. Slickwater fracturing methods. The methods comprise: introducing a slickwater fracturing fluid into a subterranean formation, wherein the slickwater fracturing fluid comprises: an aqueous formate fluid comprising about 5 weight percent (wt %) to about 50 wt % of formate anions, based on a total weight of the slickwater fracturing fluid; proppant particulates; and optionally, one or more additives; contacting the slickwater fracturing fluid with a matrix of the subterranean formation above a fracture gradient pressure thereof to create or extend one or more fractures therein; and retaining at least a portion of the formate anions within the subterranean formation.

B: Slickwater fracturing fluids. The fluids comprise: an aqueous formate fluid comprising about 5 weight percent (wt %) to about 50 wt % formate anions, based on a total weight of the slickwater fracturing fluid; proppant particulates; and optionally, one or more additives.

Each of Embodiments A or B may have one or more of the following additional elements in any combination.

Element 1: wherein the one or more additives are present and comprise at least one additive selected from the group consisting of a friction reducer, a diverter, a surfactant, a clay stabilizer, a scale inhibitor, a biocide, a corrosion inhibitor, a gelling agent, a crosslinking agent, an iron control agent, a pH-adjusting agent, a non-formate salt, a gel breaker, a weighting agent, and any combination thereof.

Element 2: wherein the slickwater fracturing fluid comprises about 30 wt % to about 50 wt % of formate anions, based on total fluid mass.

Element 3: wherein the aqueous formate fluid comprises an aqueous solution of at least one formate selected from the group consisting of formic acid, sodium formate, potassium formate, cesium formate, lithium formate, calcium formate, magnesium formate, ammonium formate, and any combination thereof.

Element 4: wherein the slickwater fracturing fluid further comprises: one or more enzymes, one or more microbial organisms capable of generating the one or more enzymes, or any combination thereof, wherein the one or more enzymes are capable of: promoting a reaction of the formate anions, carbon dioxide, kerogen or any other organic matter within the subterranean formation, or any combination thereof; and/or dissolving or disintegrating kerogen or other organic matter within the subterranean formation; and/or one or more oxidants capable of acting on kerogen or any other organic matter within the subterranean formation, or any combination thereof.

Element 5: wherein the slickwater fracturing fluid comprises the one or more enzymes and optionally an acidifying agent.

Element 6: wherein the one or more enzymes comprise at least one enzyme selected from the group consisting of a laccase, a hydrolase, an oxoreductase, a lipase, and any combination thereof.

Element 7: wherein the slickwater fracturing fluid comprises the one or more microbial organisms.

Element 8: wherein the one or more microbial organisms belong to: a bacterial phylum selected from the group consisting of Actinobacteria, Pseudomonadota, Bacillota, and any combination thereof; a bacterial genus selected from the group consisting of Mycobacterium, Pseudomonas, Sphingomonas, Achromobacter, Bacillus, and any combination thereof; a fungal division selected from the group consisting of Basidiomycota, and any combination thereof; a fungal genus selected from the group consisting of Phanerochaete, Trametes, Bjerkandera, Pleurotus, and any combination thereof; or any combination thereof.

Element 9: wherein the slickwater fracturing fluid comprises the one or more oxidants, and wherein the one or more oxidants comprise at least one oxidant selected from the group consisting of a peroxide, a persulfate, a chlorate, a bromate, a hypochlorite, a permanganate, and any combination thereof.

Exemplary combinations applicable to A and B include, but are not limited to, 1 and 2; 1-3; 1 and 3; 1, 4, and 5; 1, 4, and 7; 1, 4, and 9; 2 and 3; 2 and 3; 2, 4, and 5; 2-4; 2-5; 2, 4, and 7; 2, 4, and 9; 3 and 4; 3-5; 3, 4, and 7; and 3, 4, and 9.

The present disclosure is further directed to the following non-limiting embodiments.

Embodiment 1. A method comprising:
introducing a slickwater fracturing fluid into a subterranean formation, wherein the slickwater fracturing fluid comprises:
   an aqueous formate fluid comprising about 5 weight percent (wt %) to about 50 wt % of formate anions, based on a total weight of the slickwater fracturing fluid;
   proppant particulates; and
   optionally, one or more additives;
contacting the slickwater fracturing fluid with a matrix of the subterranean formation above a fracture gradient pressure thereof to create or extend one or more fractures therein; and
   retaining at least a portion of the formate anions within the subterranean formation.

Embodiment 2. The method of Embodiment 1, wherein the one or more additives are present and comprise at least one additive selected from the group consisting of a friction reducer, a diverter, a surfactant, a clay stabilizer, a scale inhibitor, a biocide, a corrosion inhibitor, a gelling agent, a crosslinking agent, an iron control agent, a pH-adjusting agent, a non-formate salt, a gel breaker, a weighting agent, and any combination thereof.

Embodiment 3. The method of Embodiment 1 or Embodiment 2, wherein the slickwater fracturing fluid comprises about 30 wt % to about 50 wt % of formate anions, based on total fluid mass.

Embodiment 4. The method of any one of Embodiments 1-3, wherein the aqueous formate fluid comprises an aqueous solution of at least one formate selected from the group consisting of formic acid, sodium formate, potassium formate, cesium formate, lithium formate, calcium formate, magnesium formate, ammonium formate, and any combination thereof.

Embodiment 5. The method of any one of Embodiments 1-4, wherein the slickwater fracturing fluid further comprises:
one or more enzymes, one or more microbial organisms capable of generating the one or more enzymes, or any combination thereof, wherein the one or more enzymes are capable of:
promoting a reaction of the formate anions, carbon dioxide, kerogen or any other organic matter within the subterranean formation, or any combination thereof; and/or
dissolving or disintegrating kerogen or other organic matter within the subterranean formation; and/or
one or more oxidants capable of acting on kerogen or any other organic matter within the subterranean formation, or any combination thereof.

Embodiment 6. The method of Embodiment 5, wherein the slickwater fracturing fluid comprises the one or more enzymes and optionally an acidifying agent.

Embodiment 7. The method of Embodiment 6, wherein the one or more enzymes comprise at least one enzyme selected from the group consisting of a laccase, a hydrolase, an oxoreductase, a lipase, and any combination thereof.

Embodiment 8. The method of any one of Embodiments 5-7, wherein the slickwater fracturing fluid comprises the one or more microbial organisms.

Embodiment 9. The method of Embodiment 8, wherein the one or more microbial organisms belong to:
a bacterial phylum selected from the group consisting of Actinobacteria, Pseudomonadota, Bacillota, and any combination thereof;
a bacterial genus selected from the group consisting of Mycobacterium, Pseudomonas, Sphingomonas, Achromobacter, Bacillus, and any combination thereof;
a fungal division selected from the group consisting of Basidiomycota, and any combination thereof;
a fungal genus selected from the group consisting of Phanerochaete, Trametes, Bjerkandera, Pleurotus, and any combination thereof;
or any combination thereof.

Embodiment 10. The method of any one of Embodiments 5-9, wherein the slickwater fracturing fluid comprises the one or more oxidants, and wherein the one or more oxidants comprise at least one oxidant selected from the group consisting of a peroxide, a persulfate, a chlorate, a bromate, a hypochlorite, a permanganate, and any combination thereof.

Embodiment 11. A slickwater fracturing fluid, comprising:
an aqueous formate fluid comprising about 5 weight percent (wt %) to about 50 wt % formate anions, based on a total weight of the slickwater fracturing fluid;
proppant particulates; and
optionally, one or more additives.

Embodiment 12. The slickwater fracturing fluid of Embodiment 11, wherein the one or more additives are present and comprise at least one additive selected from the group consisting of a friction reducer, a diverter, a surfactant, a clay stabilizer, a scale inhibitor, a biocide, a corrosion inhibitor, a gelling agent, a crosslinking agent, an iron control agent, a pH-adjusting agent, a non-formate salt, a gel breaker, a weighting agent, or any combination thereof.

Embodiment 13. The slickwater fracturing fluid of Embodiment 11 or Embodiment 12, wherein the slickwater fracturing fluid comprises about 30 wt % to about 50 wt % of formate anions, based on total fluid mass.

Embodiment 14. The slickwater fracturing fluid of any one of Embodiments 11-13, wherein the aqueous formate fluid comprises an aqueous solution of at least one formate selected from the group consisting of formic acid, sodium formate, potassium formate, cesium formate, lithium formate, calcium formate, magnesium formate, ammonium formate, and any combination thereof.

Embodiment 15. The slickwater fracturing fluid of any one of Embodiments 11-14, wherein the slickwater fracturing fluid comprises:
one or more enzymes, one or more microbial organisms capable of generating the one or more enzymes, or any combination thereof, wherein the one or more enzymes are capable of:
   promoting a reaction of the formate anions, carbon dioxide, kerogen or any other organic matter within the subterranean formation, or any combination thereof; and/or
   dissolving or disintegrating kerogen or other organic matter within the subterranean formation; and/or
one or more oxidants capable of acting on kerogen or any other organic matter within the subterranean formation or any combination thereof.

Embodiment 16. The slickwater fracturing fluid of Embodiment 15, wherein the slickwater fracturing fluid comprises the one or more enzymes and optionally an acidifying agent.

Embodiment 17. The slickwater fracturing fluid of Embodiment 16, wherein the one or more enzymes comprise at least one enzyme selected from the group consisting of a laccase, a hydrolase, an oxoreductase, a lipase, and any combination thereof.

Embodiment 18. The slickwater fracturing fluid of any one of Embodiments 15-17, wherein the one or more microbial organisms are present and belong to:
a bacterial phylum selected from the group consisting of Actinobacteria, Pseudomonadota, Bacillota, and any combination thereof;
a bacterial genus selected from the group consisting of Mycobacterium, Pseudomonas, Sphingomonas, Achromobacter, Bacillus, and any combination thereof;
a fungal division selected from the group consisting of Basidiomycota, and any combination thereof;
a fungal genus selected from the group consisting of Phanerochaete, Trametes, Bjerkandera, Pleurotus, and any combination thereof;
or any combination thereof.

Embodiment 19. The slickwater fracturing fluid of any one of Embodiments 15-18, wherein the slickwater fracturing fluid comprises the one or more oxidants, and wherein the one or more oxidants comprise at least one oxidant selected from the group consisting of a peroxide, a persulfate, a chlorate, a bromate, a hypochlorite, a permanganate, and any combination thereof.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized that these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and are not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A method comprising:
introducing a slickwater fracturing fluid into a subterranean formation, wherein the slickwater fracturing fluid comprises:
an aqueous formate fluid comprising about 5 weight percent (wt %) to about 50 wt % of formate anions, based on a total weight of the slickwater fracturing fluid;
proppant particulates; and
optionally, one or more additives;
contacting the slickwater fracturing fluid with a matrix of the subterranean formation above a fracture gradient pressure thereof to create or extend one or more fractures therein; and
retaining at least a portion of the formate anions within the subterranean formation.

2. The method of claim 1, wherein the one or more additives are present and comprise at least one additive selected from the group consisting of a friction reducer, a diverter, a surfactant, a clay stabilizer, a scale inhibitor, a biocide, a corrosion inhibitor, a gelling agent, a crosslinking agent, an iron control agent, a pH-adjusting agent, a non-formate salt, a gel breaker, a weighting agent, and any combination thereof.

3. The method of claim 1, wherein the slickwater fracturing fluid comprises about 30 wt % to about 50 wt % of formate anions, based on total fluid mass.

4. The method of claim 1, wherein the aqueous formate fluid comprises an aqueous solution of at least one formate selected from the group consisting of formic acid, sodium formate, potassium formate, cesium formate, lithium formate, calcium formate, magnesium formate, ammonium formate, and any combination thereof.

5. The method of claim 1, wherein the slickwater fracturing fluid further comprises:
one or more enzymes, one or more microbial organisms capable of generating the one or more enzymes, or any combination thereof, wherein the one or more enzymes are capable of:
promoting a reaction of the formate anions, carbon dioxide, kerogen or any other organic matter within the subterranean formation, or any combination thereof; and/or
dissolving or disintegrating kerogen or other organic matter within the subterranean formation; and/or
one or more oxidants capable of acting on kerogen or any other organic matter within the subterranean formation, or any combination thereof.

6. The method of claim 5, wherein the slickwater fracturing fluid comprises the one or more enzymes and optionally an acidifying agent.

7. The method of claim 6, wherein the one or more enzymes comprise at least one enzyme selected from the group consisting of a laccase, a hydrolase, an oxoreductase, a lipase, and any combination thereof.

8. The method of claim 5, wherein the slickwater fracturing fluid comprises the one or more microbial organisms.

9. The method of claim 8, wherein the one or more microbial organisms belong to:
a bacterial phylum selected from the group consisting of Actinobacteria, Pseudomonadota, Bacillota, and any combination thereof;
a bacterial genus selected from the group consisting of Mycobacterium, Pseudomonas, Sphingomonas, Achromobacter, Bacillus, and any combination thereof;
a fungal division selected from the group consisting of Basidiomycota, and any combination thereof;
a fungal genus selected from the group consisting of Phanerochaete, Trametes, Bjerkandera, Pleurotus, and any combination thereof;
or any combination thereof.

10. The method of claim 5, wherein the slickwater fracturing fluid comprises the one or more oxidants, and wherein the one or more oxidants comprise at least one oxidant selected from the group consisting of a peroxide, a persulfate, a chlorate, a bromate, a hypochlorite, a permanganate, and any combination thereof.

11. A slickwater fracturing fluid, comprising:
an aqueous formate fluid comprising about 30 weight percent (wt %) to about 50 wt % formate anions, based on a total weight of the slickwater fracturing fluid;
proppant particulates;
one or more enzymes, wherein the one or more enzymes are capable of promoting a reaction of the formate anions, carbon dioxide, or any combination thereof and comprise at least one enzyme selected from the group consisting of a carboxylase, a decarboxylase, a formate dehydrogenase, a methanogen-specific enzyme, and any combination thereof;
and
optionally, one or more additives,
wherein the slickwater fracturing fluid is a non-viscosified slickwater fracturing fluid.

12. The slickwater fracturing fluid of claim 11, wherein the one or more additives are present and comprise at least one additive selected from the group consisting of a friction reducer, a diverter, a surfactant, a clay stabilizer, a scale inhibitor, a biocide, a corrosion inhibitor, an iron control agent, a pH-adjusting agent, a non-formate salt, a gel breaker, a weighting agent, or any combination thereof.

13. The slickwater fracturing fluid of claim 11, wherein the slickwater fracturing fluid comprises a saturated aqueous formate solution.

14. The slickwater fracturing fluid of claim 11, wherein the aqueous formate fluid comprises an aqueous solution of at least one formate selected from the group consisting of formic acid, sodium formate, potassium formate, cesium formate, lithium formate, calcium formate, magnesium formate, ammonium formate, and any combination thereof.

15. The slickwater fracturing fluid of claim 11, wherein the slickwater fracturing fluid further comprises:
one or more enzymes capable of dissolving or disintegrating kerogen or any other organic matter portions of the matrix of the subterranean formation and comprising at least one enzyme selected from the group consisting of a laccase, a hydrolase, an oxoreductase, a lipase, and any combination thereof;
one or more microbial organisms capable of generating the one or more enzymes capable of promoting a reaction of the formate anions, carbon dioxide, or any combination thereof and/or the one or more enzymes capable of dissolving or disintegrating kerogen or any other organic matter portions of the matrix of the subterranean formation;
one or more oxidants capable of acting on kerogen or any other organic matter portions of the matrix of the subterranean formation; or
any combination thereof.

16. The slickwater fracturing fluid of claim 11, wherein the slickwater fracturing fluid further comprises an acidifying agent.

17. (canceled)

18. The slickwater fracturing fluid of claim 15, wherein the one or more microbial organisms are present and belong to:
a bacterial phylum selected from the group consisting of Actinobacteria, Pseudomonadota, Bacillota, and any combination thereof;
a bacterial genus selected from the group consisting of Mycobacterium, Pseudomonas, Sphingomonas, Achromobacter, Bacillus, and any combination thereof;
a fungal division selected from the group consisting of Basidiomycota, and any combination thereof;
a fungal genus selected from the group consisting of Phanerochaete, Trametes, Bjerkandera, Pleurotus, and any combination thereof;
or any combination thereof.

19. The slickwater fracturing fluid of claim 15, wherein the slickwater fracturing fluid comprises the one or more oxidants, and wherein the one or more oxidants and comprise at least one oxidant selected from the group consisting of a peroxide, a persulfate, a chlorate, a bromate, a hypochlorite, a permanganate, and any combination thereof.

20. The slickwater fracturing fluid of claim 11, wherein the slickwater fracturing fluid is a non-viscosified slickwater fracturing fluid and optionally excludes a viscosifying polymer.
